(19) United States
(12) Patent Application Publication
(10) Pub. No.: US 2013/0003128 A1
(43) Pub. Date: Jan. 3, 2013

(54) IMAGE GENERATION DEVICE, METHOD, AND PRINTER

(76) Inventor: Mikio Watanabe, Miyagi (JP)

(21) Appl. No.: 13/634,539

(22) PCT Filed: Mar. 18, 2011
(86) PCT No.: PCT/JP2011/056561

§ 371 Date: Sep. 12, 2012

(30) Foreign Application Priority Data
Apr. 6, 2010 (JP) 2010-087751

(51) Int. Cl. H04N 13/02; G06F 15/00

(52) U.S. Cl. 358/1.15; 348/47; 348/E13.074

(57) ABSTRACT

An image processing device 29 for generating plural virtual view image data according to L and R view image data I(L) and I(R), and includes an imaging error detection circuit 32, a disparity map generation circuit 33, and an image generation circuit 34 for a virtual view image. The imaging error detection circuit 32 detects whether an imaging error has occurred with L and R view image data I(L) and I(R) or not. If one of the L and R view image data I(L) and I(R) is abnormal image data, the disparity map generation circuit 33 extracts a corresponding point in the abnormal image data corresponding respectively to a pixel in remaining normal image data, and generates a disparity map. The image generation circuit 34 generates the virtual view image data according to the disparity map and the normal image data.

### TECHNICAL FIELD

The present invention relates to an image generation device and method for generating a virtual view images according to viewing an object from virtual viewpoints on the basis of view images of the object created from two viewpoints, and a printer having such an image generation device.

### BACKGROUND ART

A technique for viewing a 3-dimensional image by use of a lenticular sheet having a great number of lenticules arranged horizontally is known. Linear images are arranged alternately on a back of the lenticular sheet, the linear images being formed by linearly splitting L and R view images captured from two viewpoints on the right and left. The linear images adjacent with one another are positioned under each one of the lenticules. Left and right eyes view the L and R view images with disparity through the lenticules to observe the 3-dimensional image.

By the way, if only two of the linear images for the L and R viewpoints are recorded to the back of each one of the lenticules, the 3-dimensional image of an unnatural double image form is observable.

In Patent Document 1, a printing system is disclosed, in which virtual view images are created by viewing an object from plural virtually set virtual viewpoints different from the L and R viewpoints according to electronic interpolation on the basis of the L and R view images obtained by a multi-view camera, so that the linear images are recorded to the lenticular sheet according to the L and R view images being original and the virtual view images being new. Thus, n (equal to or more than 3) images of the linear images can be arranged on the back of each of the lenticules. Stereoscopic appearance of the 3-dimensional image can be enhanced.

### PRIOR ART DOCUMENTS

### Patent Documents

Patent Document 1: Japanese Patent Laid-open Publication No. 2001-346226

### SUMMARY OF INVENTION

### Problems to be Solved by the Invention

However, if a portion of one of taking lenses is blocked by a finger of a user for photography with the multi-view camera, one of the L and R view images cannot be created properly. If the linear images are recorded to the lenticular sheet according to the virtual view images created from the L and R view images, the 3-dimensional image of an unnatural form is viewed. To prevent this, it is conceivable to dispose a sensor near to the taking lenses for detecting a touch of a finger. A warning message is indicated if the sensor detects the touch of the finger. However, disposition of the sensor with all of the multi-view cameras is not practical due to highness of a manufacturing cost.

The present invention has been brought for solving the foregoing problems. An object of the present invention is to provide an image generation device and method and printer in which virtual view images can be acceptably obtained even if failure has occurred to one of object images of the L and R viewpoints.

### Means for Solving the Problems

In order to achieve the above object, an image generation device of the present invention for generating a virtual view image according to first and second view images captured with disparity by imaging an object from different viewpoints is provided, the virtual view image being set by viewing the object from a predetermined number of virtual viewpoints different from the viewpoints, the image generation device being characterized in including a detection unit for detecting whether there is a failure in the first and second view images, a disparity map generator for operating if one of the first and second view images is an abnormal image with the failure according to a result of detection of the detection unit, for extracting a corresponding point in the abnormal image corresponding respectively to a pixel in a normal image included in the first and second view images, and for generating a disparity map for expressing a depth distribution of the object according to a result of extraction, and an image generating unit for generating the virtual view image according to the disparity map and the normal image.

Preferably, an image output unit for outputting the normal image and the virtual view image to a predetermined receiving device is provided. Preferably, a viewpoint setting unit for setting a larger number of the virtual viewpoints than the predetermined number between the viewpoints of the abnormal image and the normal image is provided. The image generating unit selects the virtual viewpoints of the predetermined number among the virtual viewpoints set by the viewpoint setting unit in a sequence according to nearness to the viewpoint of the normal image.

Preferably, the virtual viewpoints are disposed equiangularly from each other about the object. An area detector detects a region area where the failure has occurred in the abnormal image is provided. The viewpoint setting unit makes a set number of the virtual viewpoints higher according to an increase of the area.

Preferably, an image acquisition unit for acquiring the first and second view images from an imaging apparatus which includes plural imaging units for imaging the object from the different viewpoints is provided. Preferably, the failure includes at least any one of flare and an image of a blocking portion blocking a taking lens of the imaging units at least partially.

Also, a printer of the present invention is characterized in including an image generation device as defined in any one of claims 1-7, and a recording unit for, if either one of the first and second view images is the abnormal image, recording a stereoscopically viewable image to a recording medium according to the normal image and the virtual view image. Preferably, a warning device for displaying a warning if the failure has occurred with both of the first and second view images is provided.

Preferably, an image generation method of generating a virtual view image according to first and second view images captured with disparity by imaging an object from different viewpoints is provided, the virtual view image being set by viewing the object from a predetermined number of virtual viewpoints different from the viewpoints, the image generation method is characterized in including a detection step of detecting whether there is a failure in the first and second view images, a disparity map generating step of, if one of the first and second view images is an abnormal image with the failure according to a result of detection of the detection step, extracting a corresponding point in the abnormal image corresponding respectively to a pixel in a normal image included in the first and second view images, and generating a disparity map for expressing a depth distribution of the object according to a result of extraction, and an image generating step of generating the virtual view image according to the disparity map and the normal image.

### Effect of the Invention

In the image generation device and method, and printer, if one of the first and second view images is an abnormal image with failure according to a result of detection of the detection unit, a corresponding point is extracted in the abnormal image corresponding respectively to a pixel in a normal image. A disparity map is generated according to the result of the extraction. The virtual view image is generated according to the disparity map and the normal image. Consequently, good virtual view images can be obtained even if either one of the first and second view images is abnormal.

### BRIEF DESCRIPTION OF DRAWINGS

FIG. 1 is a schematic view showing a 3-dimensional printing system;

FIG. 2 is a perspective view showing a lenticular sheet viewed from its rear side;

FIG. 3 is a block diagram showing an image processing device;

FIG. 4A is a view showing one example of L view image data;

FIG. 4B is a view showing one example of R view image data;

FIG. 4C is a view showing normal viewpoint setting;

FIG. 4D is a view showing special viewpoint setting;

FIG. 5A is an explanatory view showing normal viewpoint setting;

FIG. 5B is an explanatory view showing special viewpoint setting;

FIG. 6 is a flowchart showing recording in the 3-dimensional printing system;

FIG. 7 is a flow chart showing a flow of data generation of normal disparity image data;

FIG. 8 is an explanatory view showing a data output process for the normal disparity image data;

FIG. 9 is a flow chart showing a flow of a data output process for L disparity image data;

FIG. 10A is a view showing an example of the L view image data without occurrence of an imaging error;

FIG. 10B is a view showing an example of the R view image data with occurrence of an imaging error;

FIG. 10C is a view showing an example of a disparity map generated with reference to the L view image data of FIG. 10A;

FIG. 11A is a view showing an example of the L view image data without occurrence of an imaging error;

FIG. 11B is a view showing an example of the R view image data with occurrence of an imaging error;

FIG. 11C is a view showing an example of a disparity map generated with reference to the L view image data of FIG. 11A;

FIG. 11D is a view showing an example of a disparity map generated with reference to the L view image data of FIG. 11B;

FIG. 12 is an explanatory view showing a data output process for the L disparity image data;

FIG. 13 is a flow chart showing a flow of a data output process for R disparity image data;

FIG. 14 is a flow chart showing a flow of a data output process for the L and R view image data;

FIG. 15 is a block diagram showing a construction of a printer of a second embodiment;

FIG. 16 is a block diagram showing a 3-dimensional printing system of a third embodiment;

FIG. 17 is an explanatory view showing a disparity map for normal imaging;

FIG. 18 is an explanatory view showing a disparity map for portrait imaging;

FIG. 19 is an explanatory view showing a disparity map for landscape imaging;

FIG. 20 is a flow chart showing recording of a 3-dimensional printing system of a third embodiment;

FIG. 21 is a flow chart showing a flow of a data output process for the L disparity image data of the third preferred embodiment;

FIG. 22 is an explanatory view showing the data output process for the L disparity image data of the third preferred embodiment;

FIG. 23 is a flow chart showing a data output process for R disparity image data of the third preferred embodiment;

FIG. 24 is a block diagram showing a 3-dimensional printing system of a fourth embodiment.

### MODE FOR CARRYING OUT THE INVENTION

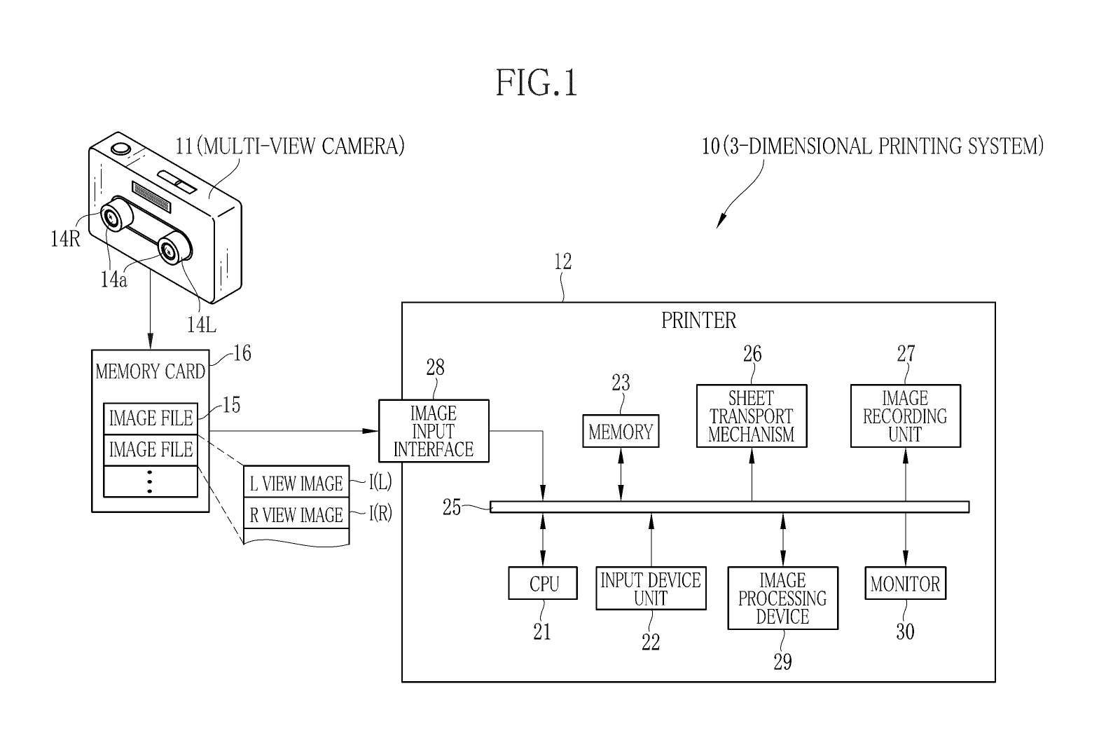

As shown in FIG. 1, a 3-dimensional printing system 10 is constituted by a multi-view camera 11 and a printer 12. The multi-view camera 11 has a pair of imaging units 14L and 14R, which create L view image data I(L) of a left viewpoint and R view image data I(R) of a right viewpoint, which have disparity in imaging an object from two different viewpoints disposed to the left and right. An image file 15 containing the L and R view image data I(L) and I(R) is recorded to a memory card 16. A reference numeral 14a designates taking lenses of the imaging units 14L and 14R.

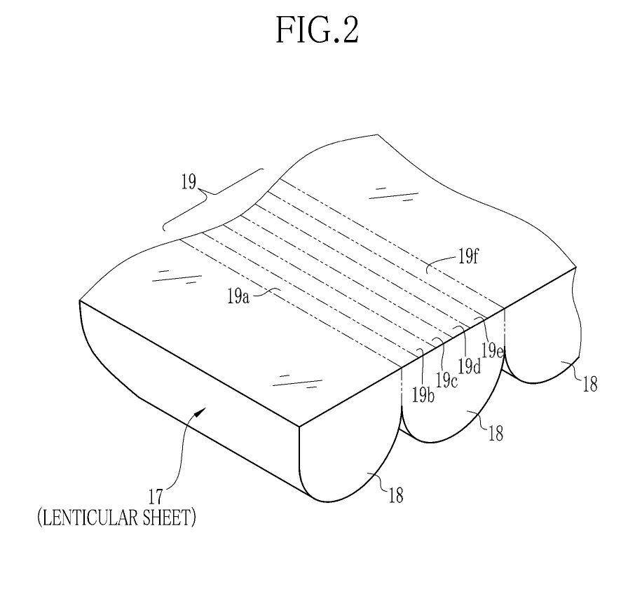

The printer 12 operates according to L and R view image data I(L) and I(R) recorded in the memory card 16, and prints plural view image data to a back surface of a lenticular sheet 17 (hereinafter referred to as sheet 17 as shown in FIG. 2) for stereoscopic imaging.

As shown in FIG. 2, a large number of lenticules 18 (herein referred to simply as lenses) of a semicylindrical shape are arranged on a front surface of the sheet 17. A back surface of the sheet 17 is flat. On the back surface, image areas 19 are virtually defined for respectively the lenticules 18. One of the image areas 19 corresponds to one of the lenticules 18.

The image areas 19 are divided in an arrangement direction of the lenticules 18 according to the number of view images. For image recording of six viewpoints, for example, the image areas 19 are divided into six areas or first to sixth small areas 19a-19f, where linear images are respectively recorded in a linearly divided manner of images of the six viewpoints. The small areas 19a-19f correspond to the images of the six viewpoints in a one-to-one correspondence.

Again in FIG. 1, a CPU 21 in the printer 12 responds to a control signal from an input device unit 22, successively runs various programs with data read from a memory 23, and entirely controls various elements in the printer 12. A RAM area in the memory 23 operates as a working memory for the CPU 21 to perform tasks and as a memory area for temporarily storing various data.

To the CPU 21 are connected the input device unit 22, the memory 23, a sheet transport mechanism 26, an image recording unit 27, an image input interface 28 (I/F), an image processing device 29 (image generation device), a monitor 30 and the like by means of a bus 25.

The input device unit 22 is used for turning on/off of a power source of the printer 12, starting image recording and the like. The sheet transport mechanism 26 transports the sheet 17 in a sub scan direction in parallel with the arrangement direction of the lenticules 18.

The image recording unit 27 records the linear images extending in a main scan direction to a back surface of the sheet 17. The image recording unit 27 records the linear images line by line at each time of transporting the sheet 17 in the sub scan direction by one line. It is therefore possible to record the linear images arranged in the sub scan direction.

In the image input interface 28, the memory card 16 is set. The image input interface 28 reads the image file 15 from the memory card 16 and sends this to the image processing device 29.

The image processing device 29 generates virtual view image data from a plurality of virtual viewpoints different from the L and R viewpoints according to L and R view image data I(L) and I(R) in the image file 15. Also, the image processing device 29, upon generation of the virtual view image data, supplies the image recording unit 27 with disparity image data of n viewpoints, which include at least one of the L and R view image data I(L) and I(R) and the virtual view image data. Note that the disparity image data are a group of discrete view image data of images directed by viewing an object from different viewpoints.

The monitor 30 displays a selection screen for selecting a menu for image recording, a setting screen for setting various parameters, and a warning message upon occurrence of difficulties.

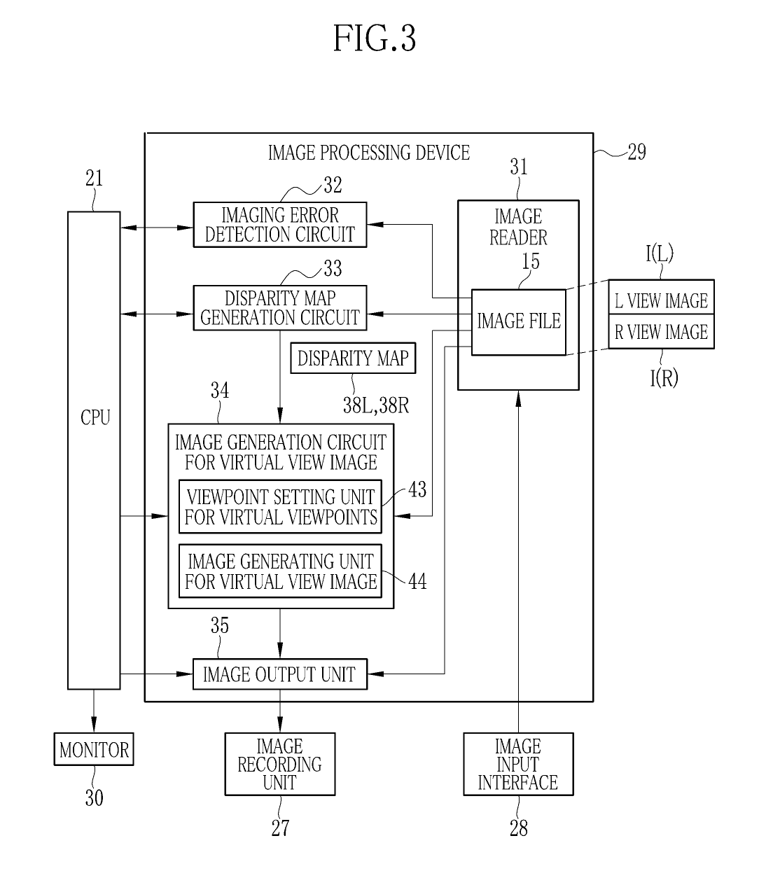

As shown in FIG. 3, the image processing device 29 includes an image reader 31 (image acquisition unit), an imaging error detection circuit 32 (detection unit), a disparity map generation circuit 33, an image generation circuit 34 for a virtual view image, and an image output unit 35.

The image reader 31 reads and memorizes the image file 15 from the memory card 16 through the image input interface 28 according to designation in the input device unit 22.

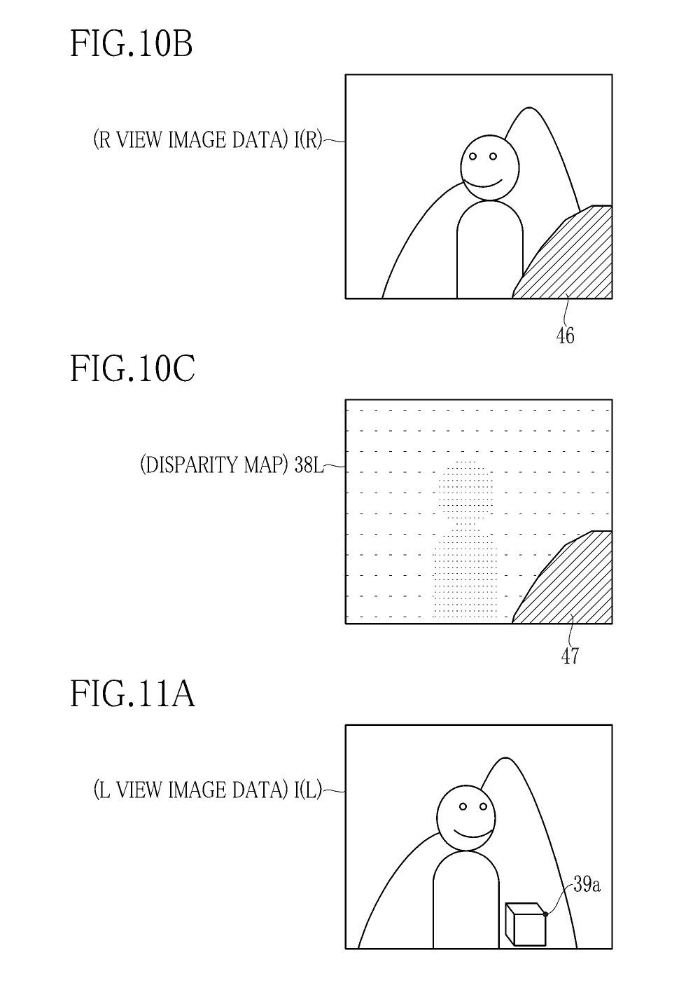

The imaging error detection circuit 32 analyzes the image file 15 in the image reader 31, and detects whether an imaging error has occurred with L and R view image data I(L) and I(R) or not. Examples of the imaging error include finger presence as physical failure, and flare as optical failure. The “finger presence” means interference of a finger (obstacle) of a user with at least one portion of the taking lenses 14a to cause appearance of an image of the finger in the object image. (See FIG. 10B.)

Occurrence of the finger presence is detectable, for example, by previously storing a plurality of image patterns captured upon occurrence of finger presence and by checking similarity of those image patterns to the L and R view image data I(L) and I(R). Occurrence of the flare is detectable, for example, by comparing the L and R view image data I(L) and I(R), and by checking whether a difference in brightness between portions of those data is higher than a predetermined threshold.

The disparity map generation circuit 33 generates a disparity map expressing distribution of a depth of an object according to the L and R view image data I(L) and I(R) in the image reader 31, and outputs the disparity map to the image generation circuit 34. The disparity map generation circuit 33 generates at least one of a disparity map 38L with reference to the L view image data I(L) and a disparity map 38R with reference to the R view image data I(R). Description is made now for an example of method of generating the disparity map 38L.

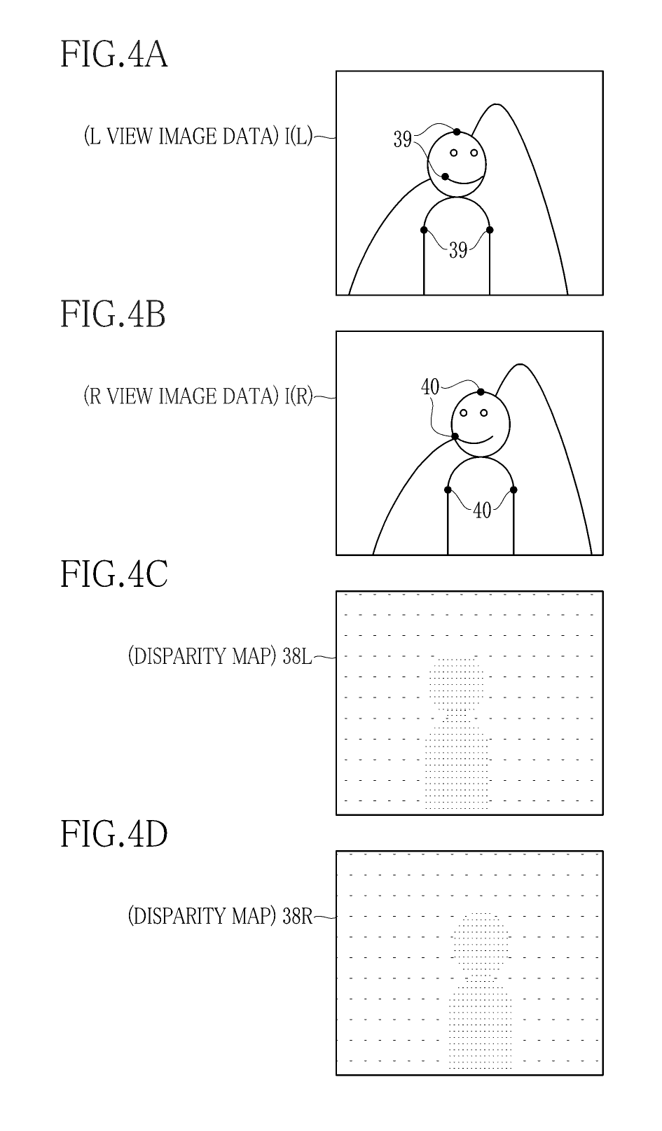

As shown in FIGS. 4A and 4B, pixels 40 (corresponding points) in the R view image data I(R) are extracted in association with respectively pixels 39 in the L view image data I(L) in relation to a common area in the L and R view image data I(L) and I(R). In the drawings, representative examples of the pixels 39 and the corresponding point 40 are shown. A method of extracting the corresponding point 40 is a template matching method disclosed in Patent Document 1 described above and other methods, any one of which can be used.

Then a position shift of the corresponding point 40 in the R view image data I(R) relative to each of the pixels 39 in the L view image data I(L) in the horizontal direction is obtained. Thus, disparity for each of the pixels 39 of the L view image data I(L) is obtained, so as to constitute the disparity map 38L shown in FIG. 4C. In the drawing, highness in the density of the dots means nearness to the multi-view camera 11. Portions with high density of dots indicate principal objects such as a person near to the multi-view camera 11. Portions with low density of dots indicate background far from the multi-view camera 11.

On the other hand, the disparity map 38R shown in FIG. 4D is generated by obtaining a position shift of the corresponding point 40 in the L view image data I(L) relative to each of the pixels 39 in the R view image data I(R).

Again in FIG. 3, the image generation circuit 34 generates virtual view image data of an object viewed from virtual viewpoints different from the right and left viewpoints. The image generation circuit 34 includes a viewpoint setting unit 43 for virtual viewpoints, and an image generating unit 44 for a virtual view image.

The viewpoint setting unit 43 sets plural virtual viewpoints between the L and R viewpoints. The viewpoint setting unit 43 selectively carries out either of normal viewpoint setting and special viewpoint setting which will be hereinafter described.

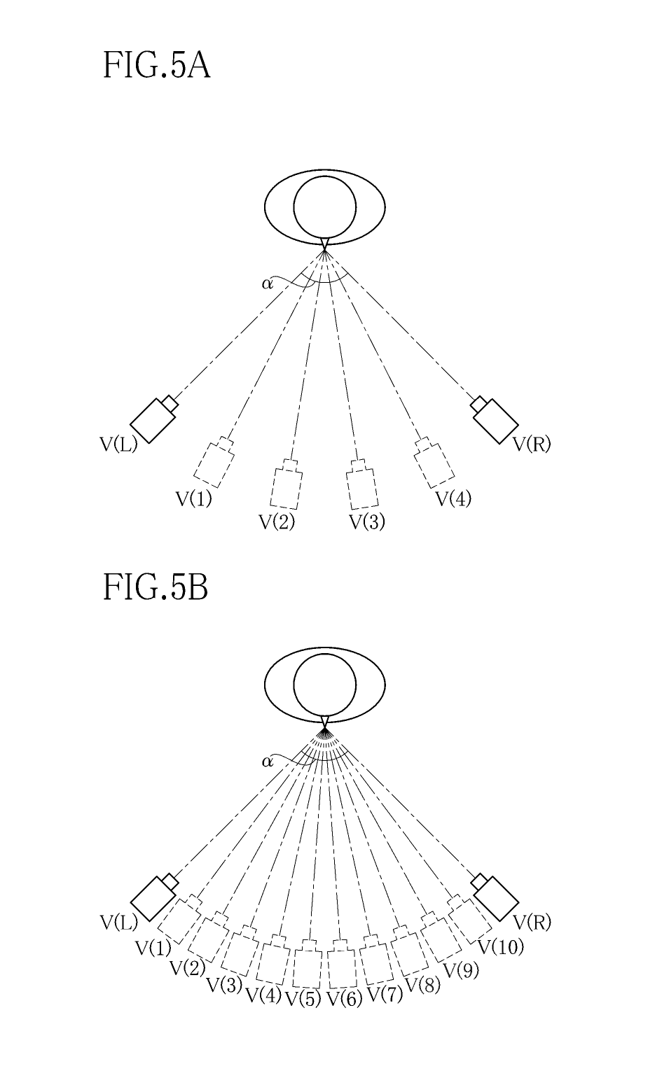

In FIG. 5A, the normal viewpoint setting operates to set (n−2)=4 virtual viewpoints V(1) to V(4) according to n=6 viewpoints. The virtual viewpoints V(1) to V(4) are determined equiangularly to divide the convergence angle α by 5, the convergence angle α being defined between viewpoint directions of the L viewpoint V(L) and the R viewpoint V(R).

In FIG. 5B, the special viewpoint setting operates to set (2n−2)=10 virtual viewpoints V(1) to V(10) according to n=6 viewpoints. The virtual viewpoints V(1) to V(10) are determined equiangularly to divide the convergence angle α by 11.

Again in FIG. 3, the image generating unit 44 generates virtual viewpoint data corresponding to the virtual viewpoints set by the viewpoint setting unit 43, and sends the virtual viewpoint data to the image output unit 35. The image generating unit 44, upon carrying out the normal viewpoint setting, performs the normal image generation, and upon carrying out the special viewpoint setting, performs the special image generation.

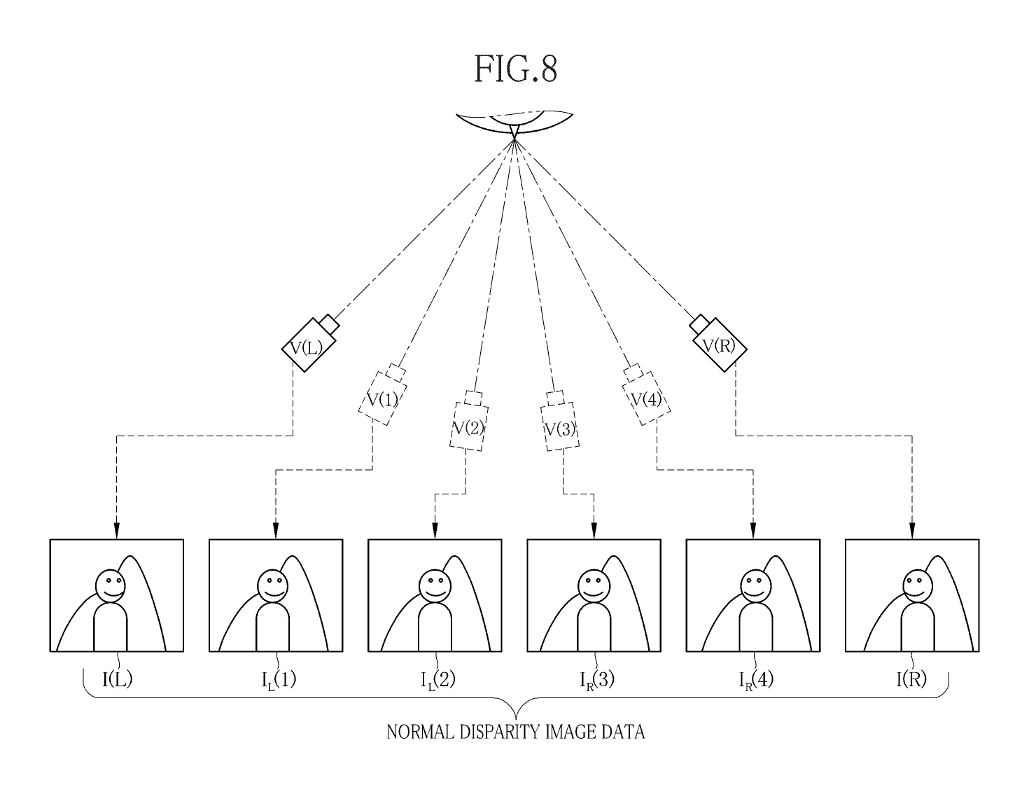

In the normal image generation, L normal image generation and R normal image generation are carried out successively. In the L normal image generation, virtual view image data is generated from a virtual viewpoint disposed on a side of an L viewpoint V(L) from the center defined between the L and R viewpoints V(L) and V(R). (See FIG. 8.) Specifically, virtual view image data (hereinafter referred to as L virtual view image data) is generated according to the L view image data I(L) and the disparity map 38L.

In the R normal image generation, on the other hand, virtual view image data is generated from a virtual viewpoint disposed on a side of an R viewpoint V(R) from the center defined between the L and R viewpoints V(L) and V(R). Specifically, virtual view image data (hereinafter referred to as R virtual view image data) is generated according to the R view image data I(R) and the disparity map 38R. Consequently, (n−2) L and R virtual view image data in all on the right and left sides are generated.

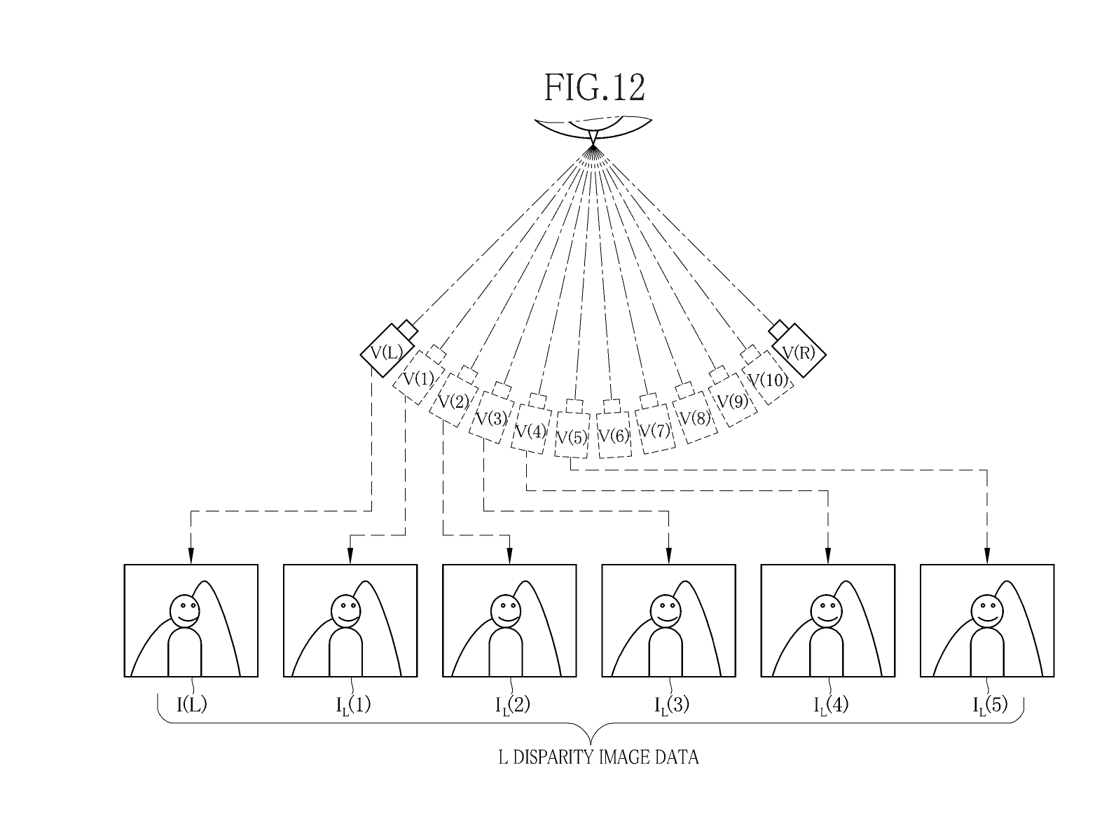

In the special image generation, one of the L and R special image generations is selectively carried out. In the L special image generation, (n−1) virtual viewpoints are selected in an order of nearness to the L viewpoint V(L), so as to generate L virtual view image data corresponding to the virtual viewpoints. (See FIG. 12.) In the R special image generation, (n−1) virtual viewpoints are selected in an order of nearness to the R viewpoint V(R), so as to generate R virtual view image data corresponding to the virtual viewpoints. Thus, (n−1) L virtual view image data or (n−1) R virtual view image data are generated.

The image output unit 35, when the virtual view image data is input by the image generating unit 44, outputs disparity image data of n viewpoints to the image recording unit 27. In case of no input of virtual view image data, the image output unit 35 outputs L and R view image data I(L) and I(R) in the image reader 31 to the image recording unit 27. The disparity image data of n viewpoints is any one of normal disparity image data, L disparity image data and R disparity image data described below, according to the number and type of the virtual view image data input from the image generating unit 44.

The normal disparity image data are constituted by (n−2) data of L and R virtual view image data from the image generating unit 44, and L and R view image data I(L) and I(R) from the image reader 31. The L disparity image data is constituted by (n−1) L virtual view image data from the image generating unit 44, and L view image data I(L) from the image reader 31. The R disparity image data is constituted by (n−1) R virtual view image data from the image generating unit 44, and R view image data I(R) from the image reader 31.

The CPU 21 selectively carries out an output process for the normal disparity image data, an output process for the L disparity image data, an output process for the R disparity image data, and an output process for the L and R disparity image data, according to the result of the detection of the imaging error detection circuit 32.

The data output process for the normal disparity image data is carried out when both of the L and R view image data I(L) and I(R) have been captured properly. The data output process for the L disparity image data is carried out when an imaging error has occurred with the R view image data I(R). The data output process for the R disparity image data is carried out when an imaging error has occurred with the L view image data I(L).

The data output process for the L and R view image data is carried out when an imaging error has occurred with both of the L and R view image data I(L) and I(R). The CPU 21 causes the monitor 30 to display a warning message and the like for the fact that the imaging error have occurred with both of the L and R view image data I(L) and I(R).

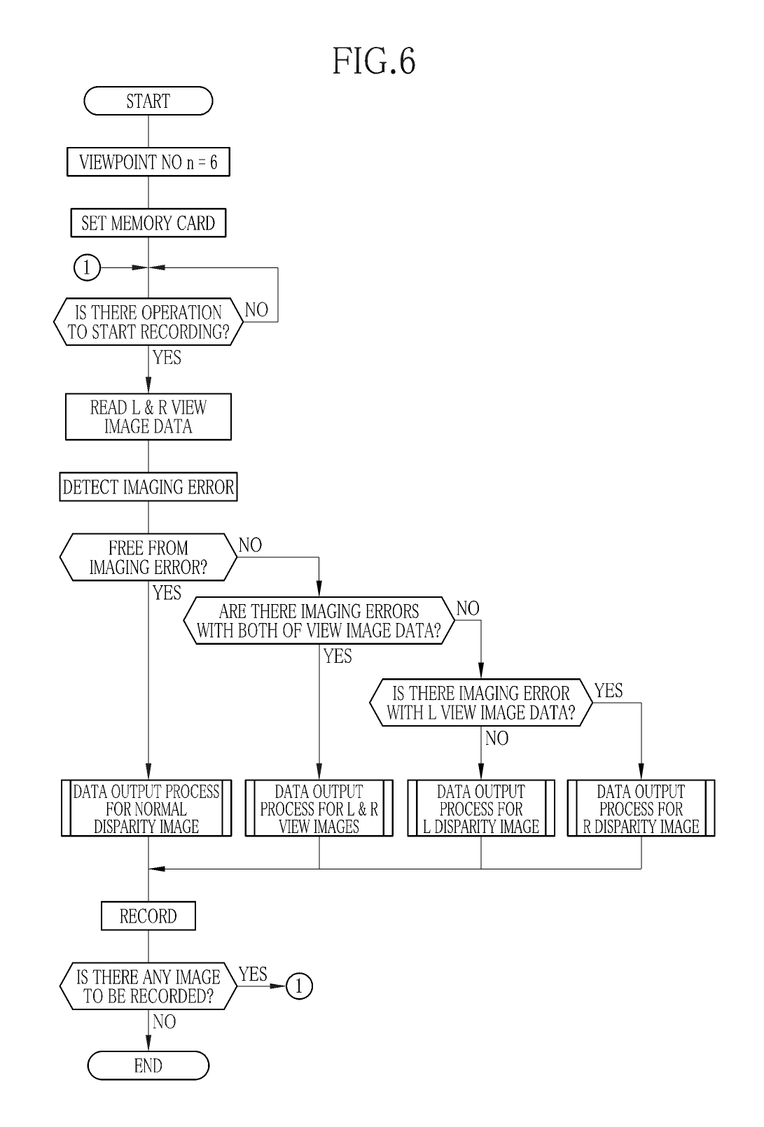

Image recording of the 3-dimensional printing system 10 constructed above is described by use of the flow chart of FIG. 6. The description is made for a structure in which an image of six viewpoints (n=6) is to be recorded to the sheet 17.

At first, the memory card 16 removed from the multi-view camera 11 is set on the image input interface 28. After the setting, the input device unit 22 selects the image file 15 for start of the recording. The CPU 21 sends a command for reading the image file 15 to the image reader 31. Thus, the image reader 31 reads the designated image file 15 from the memory card 16 through the image input interface 28, and stores this in a temporary manner.

Then the CPU 21 sends a command of detecting an imaging error to the imaging error detection circuit 32. The imaging error detection circuit 32 in response to the command analyzes the L and R view image data I(L) and I(R) in the image reader 31, checks occurrence of the imaging error of the L and R view image data I(L) and I(R), and sends a result of the detection to the CPU 21.

The CPU 21 carries out the data output process for the normal disparity image data in case of no occurrence of an imaging error with any of the L and R view image data I(L) and I(R). Also, the CPU 21 carries out the data output process for the L disparity image data in case of occurrence of an imaging error with the R view image data I(R), and carries out the data output process for the R disparity image data in case of occurrence of an imaging error with the L view image data I(L). The CPU 21 performs the data output process for the L and R view image data in case of occurrence of an imaging error with both of the L and R view image data I(L) and I(R).

[Data Output Process for Normal Disparity Image Data]

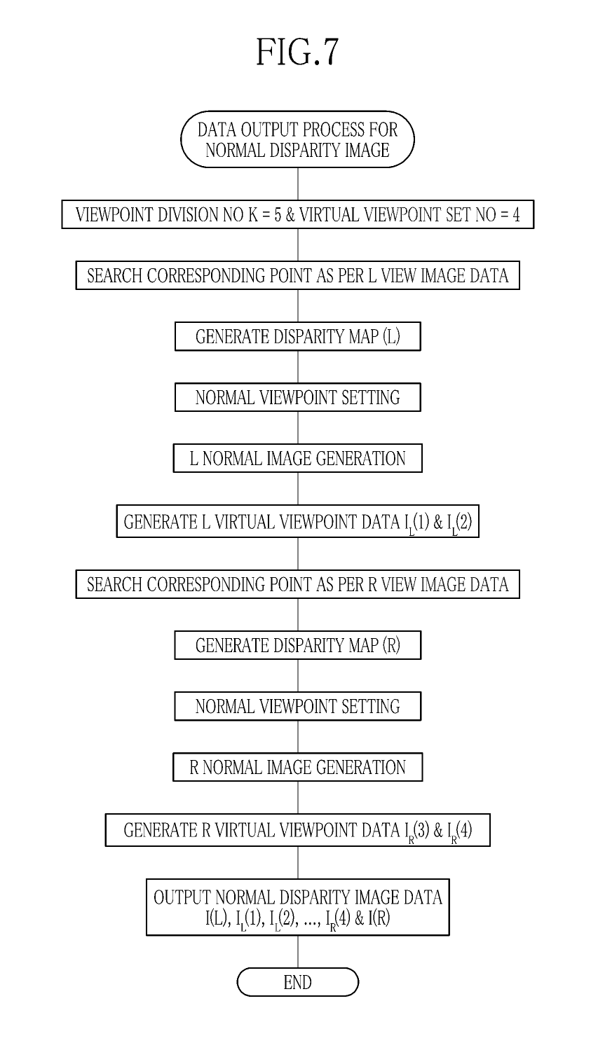

As shown in FIG. 7, carrying out of data output process for normal disparity image data is decided. A division number (hereinafter referred to as a viewpoint division number) K for dividing the convergence angle α is determined as “5”. A set number of the virtual viewpoints is determined as “4”. Then the CPU 21 sends a command for generating the disparity map 38L to the disparity map generation circuit 33. The disparity map generation circuit 33 in response to the command extracts the corresponding point 40 in the R view image data I(R) corresponding to the pixels 39 in the L view image data I(L), and generates the disparity map 38L according to the result of the extraction. The disparity map 38L is output to the image generation circuit 34.

The CPU 21 sends a command for the normal viewpoint setting to the viewpoint setting unit 43. The viewpoint setting unit 43 responsively starts the normal viewpoint setting shown in FIG. 5A. The viewpoint setting unit 43 obtains a disparity value corresponding to an object position the nearest to the multi-view camera 11 and a disparity value corresponding to an object position the farthest from the multi-view camera 11. Then the virtual viewpoints V(1) to V(4) are set so that the nearest object is viewed in front of the recording surface of the sheet 17 at a predetermined distance, and that the farthest object is viewed behind the recording surface of the sheet 17 at a predetermined distance. Note that well-known methods can be used for the method of setting the virtual viewpoints.

Then the CPU 21 sends a command for carrying out the L normal image generation to the image generating unit 44. Thus, the image generating unit 44 generates L virtual view image data IL(1) and IL(2) corresponding to the virtual viewpoints V(1) and V(2) according to the disparity map 38L and the L view image data I(L). Note that a method of generating virtual view image data according to the disparity map and the L view image data is a well-known technique, which is not described further herein. (For example, see JP-A 2001-346226 and JP-A 2003-346188.)

After the L virtual view image data IL(1) and IL(2) are generated, the CPU 21 sends a command for generating the disparity map 38R to the disparity map generation circuit 33. The disparity map generation circuit 33 in response to the command extracts the corresponding point 40 in the L view image data I(L) corresponding to each of the pixels 39 in the R view image data I(R), and generates the disparity map 38R according to the result of the extraction.

Then the CPU 21 sends a command for setting a normal viewpoint to the viewpoint setting unit 43, and sends a command of carrying out the R normal image generation to the image generating unit 44. Thus, R virtual view image data IR(3) and IR(4) are created in association with the virtual viewpoints V(3) and V(4).

As shown in FIG. 8, the L virtual view image data IL(1) and IL(2) and the R virtual view image data IR(3) and IR(4) are generated in association with the virtual viewpoints V(1) to V(4). Thus, view image data of six viewpoints in all are obtained together with the initial L and R view image data I(L) and I(R). The virtual view image data IL(1), IL(2), IR(3) and IR(4) are input to the image output unit 35.

The CPU 21 sends a command for outputting normal disparity image data to the image output unit 35. The image output unit 35 in response to the command reads the L and R view image data I(L) and I(R) from the image reader 31. Then the image output unit 35 outputs normal disparity image data of the six viewpoints to the image recording unit 27, the normal disparity image data including the virtual view image data IL(1), IL(2), IR(3) and IR(4) and the L and R view image data I(L) and I(R). Finally, the data output process for the normal disparity image data is completed.

[Data Output Process for L Disparity Image Data]

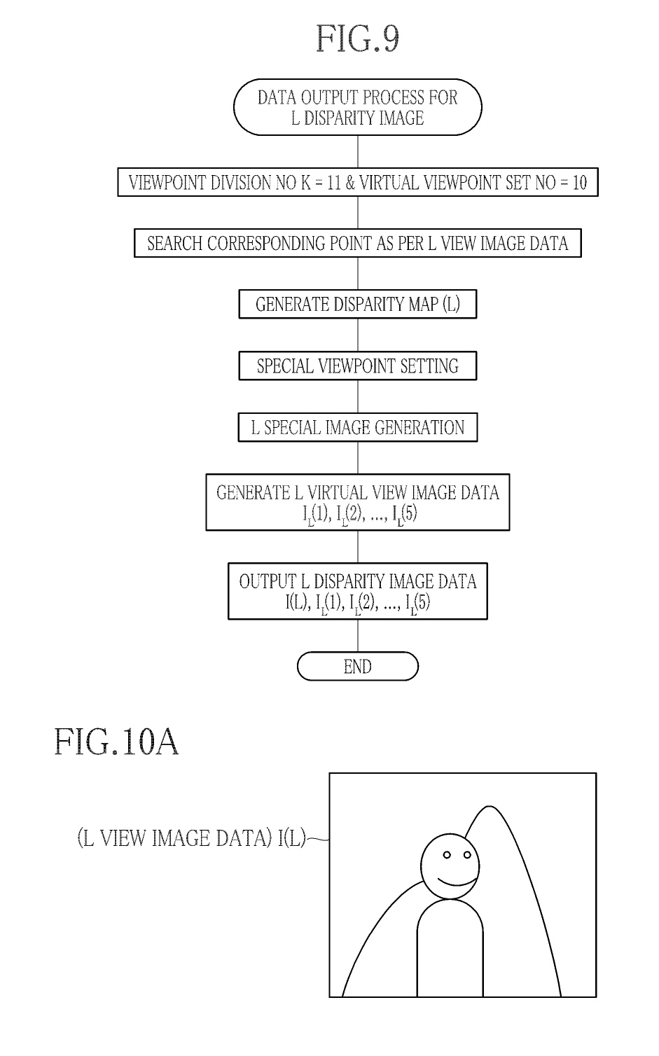

As shown in FIG. 9, carrying out of data output process for L disparity image data is decided. The division number K is determined as “11”. A set number of the virtual viewpoints is determined as “10”. Then the CPU 21 sends a command for generating the disparity map 38L to the disparity map generation circuit 33. The disparity map generation circuit 33 generates the disparity map 38L according thereto.

As shown in FIGS. 10A and 10B, there occurs a finger image 46 of finger presence (hatched) in a partial area of the R view image data I(R). As shown in FIG. 10C, an abnormal area 47 (hatched) occurs also in the disparity map 38L with an abnormal value of the disparity due to the finger image 46. The disparity map 38L can have distribution of depth of an object with higher precision than the disparity map 38R even with the abnormal area 47, which will be hereinafter described.

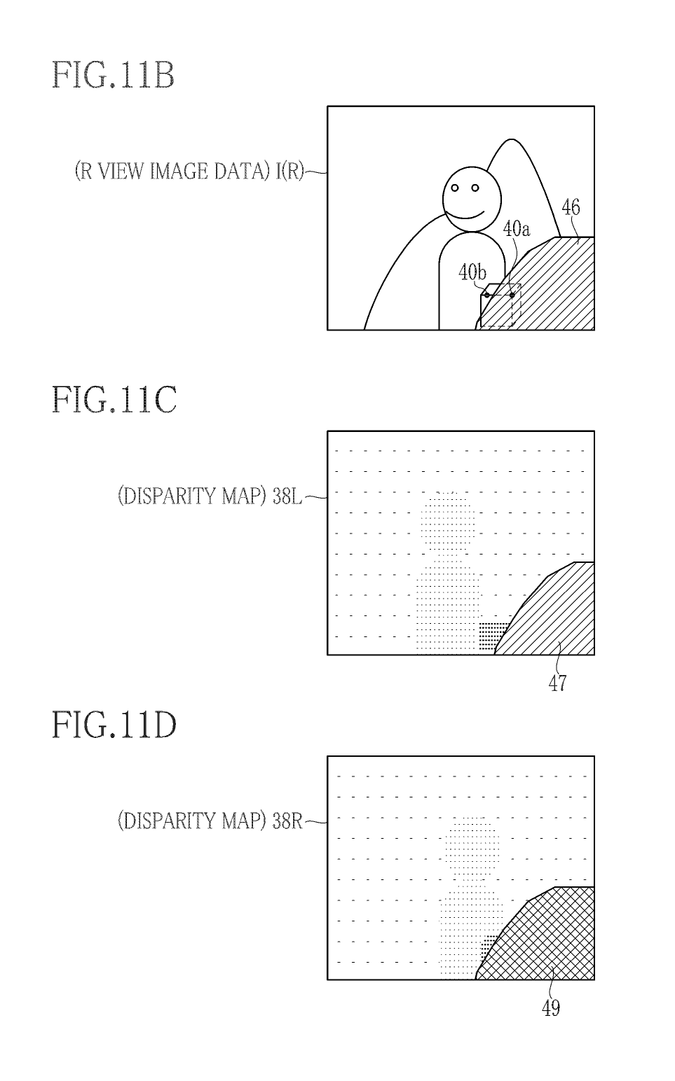

As shown in FIGS. 11A and 11B, for example, a corresponding point 40a in the R view image data I(R), which corresponds to a pixel 39a in the L view image data I(L), is hidden by the finger image 46. In such a state, a pixel near to the corresponding point 40a and not hidden by the finger image 46 can be a corresponding point 40b, so as to obtain disparity between the pixel 39a and the corresponding point 40b. The value of this disparity, although incorrect due to a result of incorrect correspondence, may be a value for expressing a certain depth of an object. As shown in FIG. 11C, therefore, a disparity value of the abnormal area 47 may be a value for expressing a certain depth of the object in the disparity map 38L obtained by search of corresponding points with reference to the L view image data I(L) captured normally.

Upon the search of corresponding points with reference to the R view image data I(R) after generation of the finger image 46, no disparity value is found, because no corresponding point is present in association with respective pixels of the finger image 46 in the L view image data I(L). As shown in FIG. 11D, a disparity value of an abnormal area 49 is a default value (normally 0 or 255) in the disparity map 38R obtained by search of corresponding points with reference to the R view image data I(R). Therefore, distribution of depth of an object according to the disparity map 38L can be obtained with higher precision than according to the disparity map 38R.

For the reasons described heretofore, the disparity map 38L is generated in case of occurrence of an imaging error in the R view image data I(R). The disparity map 38L is outputted to the image generation circuit 34. Then the CPU 21 sends a command for setting special viewpoints to the viewpoint setting unit 43.

As shown in FIG. 12, the viewpoint setting unit 43 upon receiving the special viewpoint setting command sets virtual viewpoints V(1) to V(10) by performing the special viewpoint setting. Then the CPU 21 sends a command of performing the L special image generation to the image generating unit 44.

The image generating unit 44 upon receiving the command from the CPU 21 generates L virtual view image data IL(1) to IL(5) corresponding to the virtual viewpoints V(1) to V(5) according to the disparity map 38L and the L view image data I(L). The finger image 46 is not included in the virtual view image data, because the virtual view image data is generated according to the normal L view image data I(L).

The abnormal area 47 as shown in FIG. 11C has occurred in the disparity map 38L. Probability of occurrence of failure in the L virtual view image data corresponding to the virtual viewpoint is higher according to nearness of the virtual viewpoint to the R viewpoint V(R). Also, the degree of the failure becomes higher. It is noted that the failure means, for example, a state in which a portion of the background appears in front of a principal object disposed at the center of the image.

The image generating unit 44 generates the L virtual view image data IL(1) to IL(5) corresponding to the five virtual viewpoints V(1) to V(5) according to nearness to the L viewpoint V(L). Probability of occurrence of a failure with those image data will be low. Should such a failure occur, the degree of the error will be small. The L virtual view image data IL(1) to IL(5) are input to the image output unit 35.

The CPU 21 sends a command for outputting L disparity image data to the image output unit 35. Thus, the image output unit 35 outputs the L disparity image data of the six viewpoints to the image recording unit 27, the L disparity image data including the L virtual view image data IL(1) to IL(5) and the L view image data I(L) read from the image reader 31. Then the data output process for the L disparity image data is completed.

[Data Output Process for R Disparity Image Data]

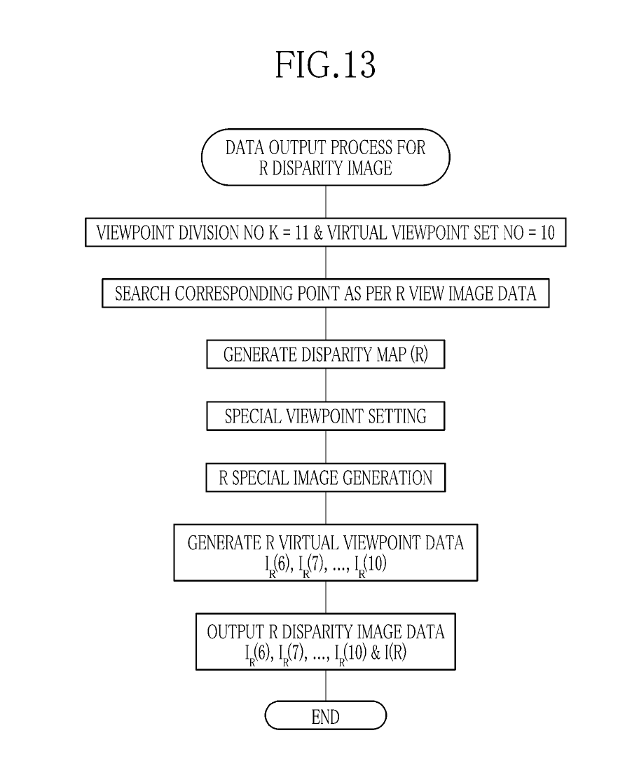

As shown in FIG. 13, a flow of the data output process for R disparity image data is basically the same as that of the data output process for the L disparity image data. Note that the disparity map 38R is generated in the data output process for the R disparity image data. Then R virtual view image data IR(6) to IR(10) corresponding to five virtual viewpoints V(6) to V(10) are generated according to the disparity map 38R and the R view image data I(R), the five virtual viewpoints being in a sequence according to their nearness to the R viewpoint V(R). Thus, the R disparity image data of the six viewpoints are outputted to the image recording unit 27, including the R virtual view image data IR(6) to IR(10) and the R view image data I(R). Then the data output process for the R disparity image data is completed.

[Data Output Process for L and R View Image Data]

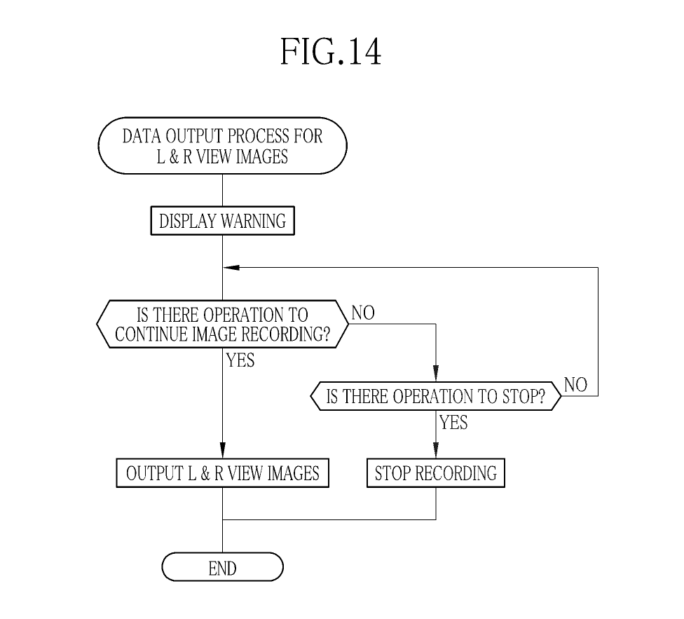

As shown in FIG. 14, the CPU 21, upon determining carrying out of the data output process for L and R view image data, causes the monitor 30 to display a warning that an imaging error has occurred in both of the L and R view image data I(L) and I(R). Furthermore, the CPU 21 stops the image recording temporarily, and causes the monitor 30 to display a message as to whether the image recording should be continued or not.

When the input device unit 22 is operated for continuing the image recording, the CPU 21 sends a command for outputting the L and R view image data to the image output unit 35. The image output unit 35 reads the L and R view image data I(L) and I(R) from the image reader 31 and sends those to the image recording unit 27. If the input device unit 22 is operated for stopping the image recording, the CPU 21 stops the image recording.

Again in FIG. 6, the CPU 21 sends a command of image recording of six viewpoints to the image recording unit 27 when any one of the normal disparity image data and L and R disparity image data is input to the image recording unit 27. In response to the command, the image recording unit 27 records linear images to a back of the sheet 17, the linear images being formed by linearly splitting the view images of the six viewpoints. Owing to the recording on the basis of the L and R disparity image data, stereo appearance of the 3-dimensional image is lower than the recording on the basis of the normal disparity image data. However, no failure of imaging such as the finger image 46 and flare is indicated, so that the 3-dimensional image can be viewed adequately.

On the other hand, when only the L and R disparity image data I(L) and I(R) are input to the image recording unit 27, the CPU 21 sends a command of image recording of two viewpoints to the image recording unit 27. In response to the command, the image recording unit 27 records linear images to the back of the sheet 17, the linear images being formed by respectively splitting the L and R disparity image data I(L) and I(R) linearly. Also, the process described above is carried out repeatedly for image recording of the remaining image file 15 in the memory card 16.

In the first embodiment described above, the description has been made for the structure in which disparity image data of the six viewpoints is recorded to the sheet 17. It is possible to use the present invention for a structure in which disparity image data of three or more viewpoints is recorded to the sheet 17. L and R virtual view image data generated by a data output process for respective disparity image data for recording the disparity image data of n viewpoints to the sheet 17 are expressed according to expressions 1-3 as follows:

1. Data Output Process for the Normal Disparity Image Data

(1) Division number of viewpoints: K=n−1

(2) Set number of virtual viewpoints: n

(3) L virtual view image data: IL(1), IL(2), . . . , IL((K+1)/2−1)

(4) R virtual view image data: IR((K+1)/2), IR((K+1)/2+1), . . . , IR(K−1)

2. Data Output Process for the L Disparity Image Data

(1) Division number of viewpoints: K=2n−1

(2) Set number of virtual viewpoints: n

(3) L virtual view image data: IL(1), IL(2), . . . , IL((K+1)/2−1)

3. Data Output Process for the R Disparity Image Data

(1) Division number of viewpoints: K=2n−1

(2) Set number of virtual viewpoints: n

(3) R virtual view image data: IR((K+1)/2), IR((K+1)/2+1), . . . , IR(K−1)

### 2nd Embodiment

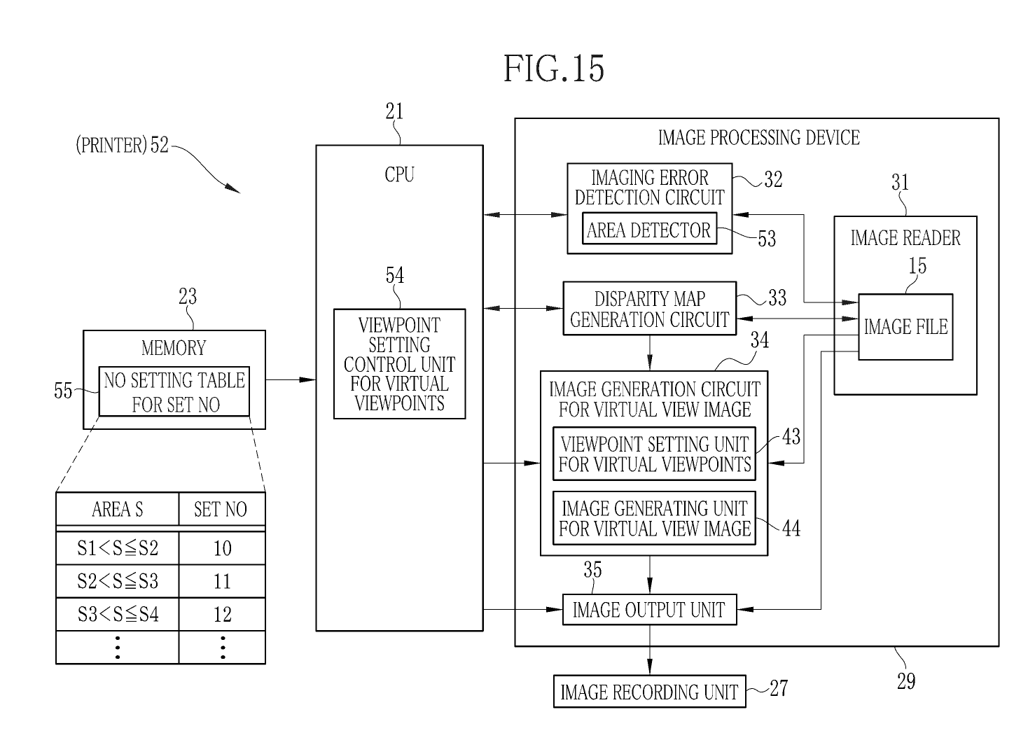

A printer 52 of a second embodiment of the invention is described by referring to FIG. 15. In the first embodiment described above, the set number of the virtual viewpoints set in the special viewpoint setting is predetermined. In contrast, the printer 52 sets the set number of the virtual viewpoints according to an area of a region (hereinafter referred to simply as an imaging error region) of occurrence of an imaging error such as the finger image 46 in the L and R view image data.

The printer 52 is constructed in a basically equal manner to the printer 12 of the first embodiment. However, the imaging error detection circuit 32 has an area detector 53. The CPU 21 operates as a viewpoint setting control unit 54 for virtual viewpoints. A number setting table 55 for the set number is stored in the memory 23.

The number setting table 55 stores an area S of the imaging error region and the set number of the virtual points in association with one another. In the number setting table 55, their association is so made that the set number of the virtual viewpoints increases according to an increase in the area S by a predetermined amount.

The area detector 53 operates when the imaging error detection circuit 32 detects occurrence of an imaging error, acquires an area S of the imaging error region, and outputs a result of the acquisition to the CPU 21. The area S is obtained, for example, by designating the imaging error region in image data and by counting a number of pixels in the region. Also, it is possible to designate the imaging error region by various matching methods for use in comparison of the image data captured normally to the image data with occurrence of the imaging error.

The viewpoint setting control unit 54 operates at the time of the special viewpoint setting and determines the set number of the virtual viewpoints. The viewpoint setting control unit 54 determines the set number of the virtual viewpoints by referring to the number setting table 55 of the memory 23 and according to a value of the area S input by the area detector 53, and sends a result of the determination to the viewpoint setting unit 43. Therefore, the set number of the virtual viewpoints in the special viewpoint setting can be increased or decreased according to the area S of the imaging error region.

If the area S of the imaging error region is large, it is possible to increase the set number of virtual viewpoints. Positions of the virtual viewpoints of respectively the virtual view image data can be set nearer to the L and R viewpoints where no imaging error has occurred. In FIG. 12, for example, the set number of the virtual viewpoints increases from 10 to 20. Then positions of the virtual viewpoints V(1) to V(5) come nearer to the L viewpoint V(L). Thus, influence of an imaging error to the virtual view image data can be reduced.

### 3rd Embodiment

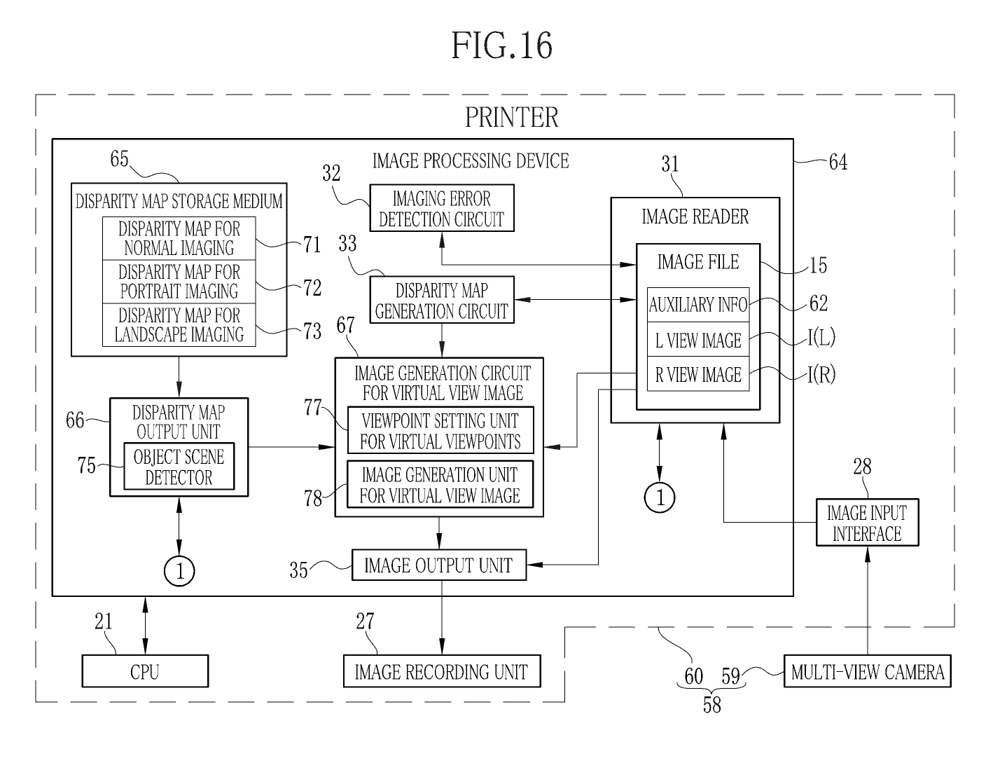

A 3-dimensional printing system 58 of a third embodiment of the present invention is described now by use of FIG. 16. In the first embodiment, virtual view image data is generated according to the disparity map generated by the disparity map generation circuit 33 in the course of the data output process for the L and R disparity image data. In contrast, the 3-dimensional printing system 58 generates virtual view image data by use of a previously stored disparity map in case of occurrence of an imaging error in either one of the L and R view image data I(L) and I(R). The 3-dimensional printing system 58 is constituted by a multi-view camera 59 and a printer 60.

The multi-view camera 59 is basically the same as the multi-view camera 11 of the first embodiment. Imaging modes of the multi-view camera 59 are a portrait imaging mode, landscape imaging mode and normal imaging mode. The portrait imaging mode is a mode for imaging in an imaging condition suitable for portrait imaging, for example, by focusing on a near field. The landscape imaging mode is a mode for imaging in an imaging condition suitable for landscape imaging, for example, by focusing on a far field. The normal imaging mode is a mode for widely covering an imaging condition suitable for portrait imaging and landscape imaging. The multi-view camera 59 assigns the image file 15 with auxiliary information 62 for expressing a mode setting of the imaging modes at the time of recording the image file 15 to the memory card 16.

The printer 60 is constructed in a basically equal manner to the printer 12 of the first embodiment described above. However, an image processing device 64 of the printer 60 has a disparity map storage medium 65, a disparity map output unit 66, and an image generation circuit 67 for a virtual view image.

The disparity map storage medium 65 stores a disparity map 71 for normal imaging, a disparity map 72 for portrait imaging, and a disparity map 73 for landscape imaging.

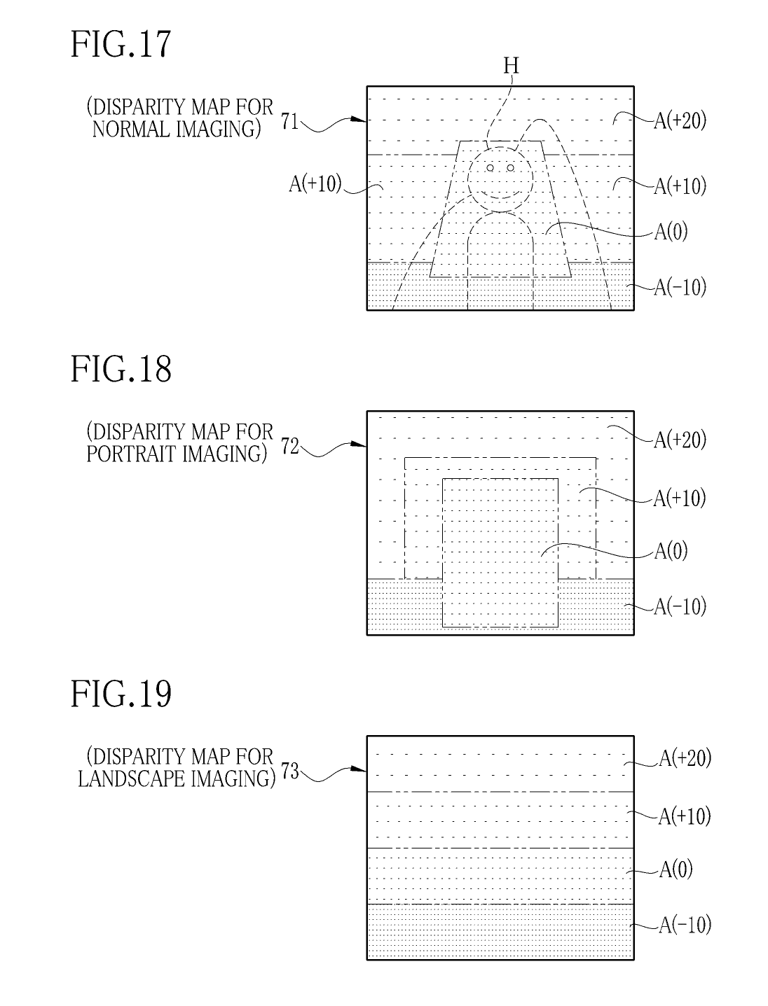

As shown in FIG. 17, the disparity map 71 is an image in consideration of L and R view image data in which a principal object H is disposed at a center of a frame, an object in a lower portion of the frame is disposed in front of the principal object H, and an object in an upper portion of the frame is disposed behind the principal object H. The disparity map 71 is divided into four areas including an area A(0) where the disparity value is set as zero, an area A(−10) where the disparity value is set as −10, an area A(+10) where the disparity value is set as +10, and an area A(+20) where the disparity value is set as +20. The areas are so indicated with reference to the area A(0) that area disposition is more forward according to smallness of its disparity value, and is more backward according to greatness of its disparity value.

The area A(0) is substantially in an trapezoidal shape, and set at the center of the map. This is because a viewer is the most likely to gaze at the principal object H and his or her eye fatigue may increase in case of occurrence of disparity at the center of the map. The other areas including the area A(−10), area A(+10) and area A(+20) are disposed in a lower portion, intermediate portion and upper portion of the map different from the center of the map.

As shown in FIG. 18, the disparity map 72 is an image in consideration of L and R view image data obtained by portrait imaging. In the disparity map 72, the area A(0) of substantially a rectangular shape is disposed at the center of the lower portion of the map and at the center of the map. The area A(−10) is disposed at the lower portion of the map and on the periphery of a lower end of the area A(0). The area A(+10) is disposed on the periphery of a portion of the area A(0) in a region other than the area A(−10). The area A(+20) is disposed on the periphery of the area A(+10).

As shown in FIG. 19, the disparity map 73 is a map in consideration of L and R view image data obtained by landscape imaging. In the disparity map 73, an area A(−10), area A(0), area A(+10) and area A(+20) of a belt shape are determined serially from a lower portion to an upper portion of the map.

Again in FIG. 16, the disparity map output unit 66 selects a disparity map (hereinafter referred to as an optimum disparity map) which is the most suitable to an object scene of the image file 15 among the disparity maps 71-73 in the disparity map storage medium 65, and outputs this to the image generation circuit 67. The disparity map output unit 66 has an object scene detector 75.

The object scene detector 75 refers to the auxiliary information 62 of the image file 15, checks the mode setting of the imaging mode upon obtaining the image file 15, and judges that a category of an object scene of the image file 15 is any one of the portrait imaging, landscape imaging and normal imaging.

The image generation circuit 67 generates virtual view image data in a basically similar manner to the image generation circuit 34 of the first embodiment. However, if an imaging error has occurred with either one of the L and R view image data I(L) and I(L), a viewpoint setting unit 77 for virtual viewpoints carries out a special viewpoint setting (hereinafter referred to as special viewpoint setting X) different from the first embodiment. An image generation unit 78 for a virtual view image carries out the special image generation (hereinafter referred to as special image generation X) different from the first embodiment.

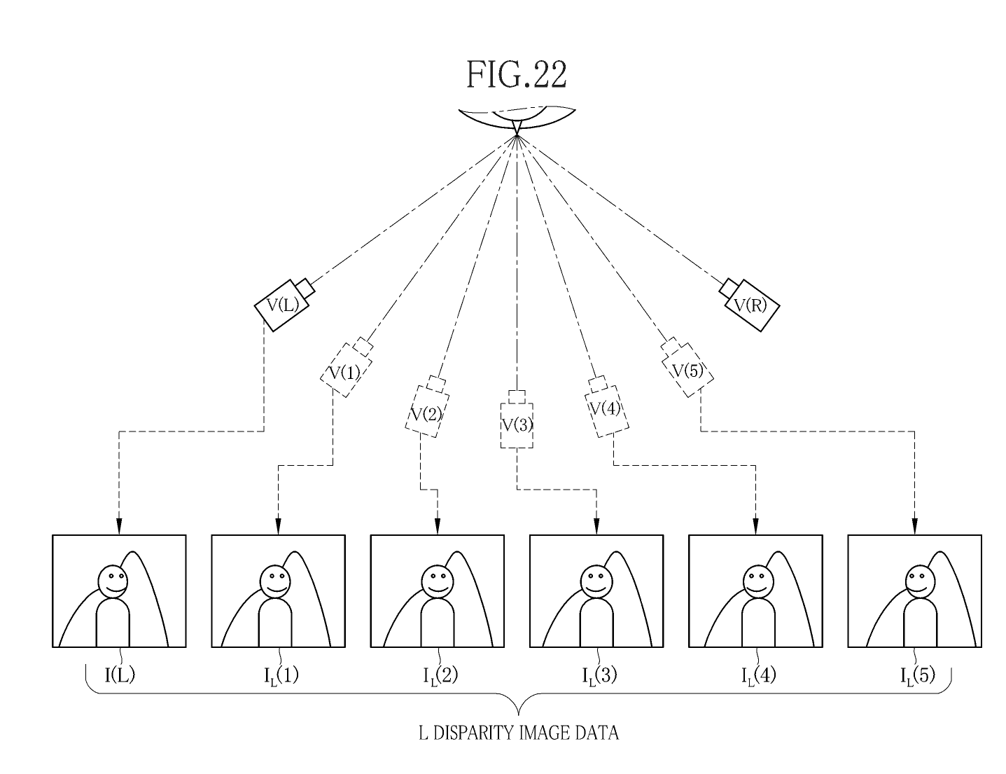

In the special viewpoint setting X, (n−1)=5 virtual viewpoints V(1) to V(5) are set in relation to n=6 viewpoints. (See FIG. 22.) This is because a disparity map stored previously is used by way of a disparity map for creating the virtual view image data, instead of using the disparity map generated according to L and R view image data after occurrence of an imaging error. Positions of virtual viewpoints of virtual view image data, in case of creating this by use of the previously stored disparity map, are not influenced by an imaging error even defined near to the viewpoints on the side of the occurrence of an imaging error.

In the special image generation X, the L and R special image generations X described below are selectively carried out according to any one of the L and R view image data I(L) and I(R) in which an imaging error has occurred.

The L special image generation X generates L virtual view image data IL(1) to IL(5) corresponding to respectively the virtual viewpoints V(1) to V(5) by use of the L view image data I(L) and the optimum disparity map. The R special image generation X generates R virtual view image data IR(1) to IR(5) corresponding to respectively the virtual viewpoints V(1) to V(5) by use of the R view image data I(R) and the optimum disparity map.

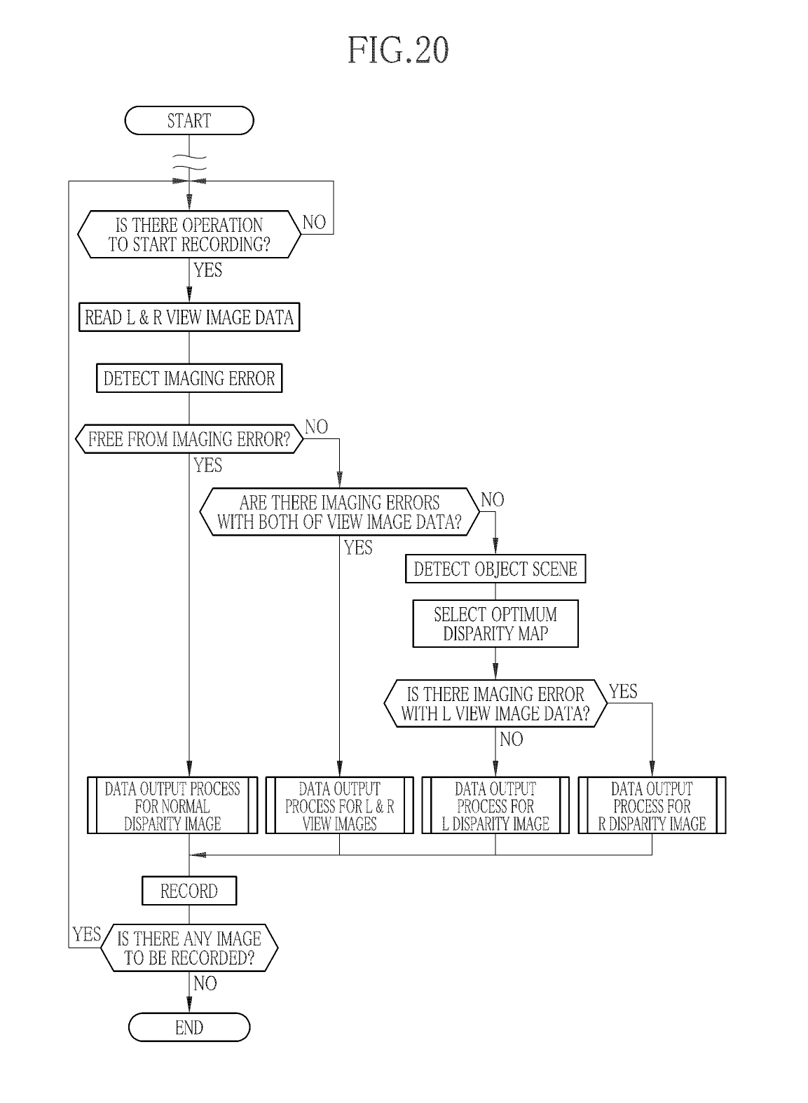

The image recording in the 3-dimensional printing system 58 constructed above is described now by referring to a flow chart in FIG. 20. The description is made for a structure in which image data of six viewpoints (n=6) is to be recorded to the sheet 17 in a manner similar to the first embodiment. Note that the processing for a state of occurrence of imaging errors in both of the L and R view image data I(L) and I(R) is the same as that in the first embodiment, and is not described further. The processing for a state of no occurrence of an imaging error in any of the L and R view image data I(L) and I(R) is the same as that in the first embodiment, and is not described further.

In case of occurrence of an imaging error in imaging in either one of the L and R view image data I(L) and I(R), the CPU 21 sends a command to the disparity map output unit 66 for outputting an image of an optimum disparity map. The disparity map output unit 66 in response to this command drives the object scene detector 75. The object scene detector 75 detects a mode setting of the imaging mode recorded in the auxiliary information 62 of the image file 15 in the image reader 31. Thus, it is judged that a category of the object scene is one of the portrait imaging, landscape imaging and normal imaging.

Then the disparity map output unit 66 selects an optimum disparity map from the disparity map storage medium 65 to correspond to a result of detection in the object scene detector 75, and sends the optimum disparity map to the image generation circuit 67. In case of occurrence of an imaging error in the R view image data I(R), the CPU 21 carries out the data output process for the L disparity image data.

[Data Output Process for L Disparity Image Data]

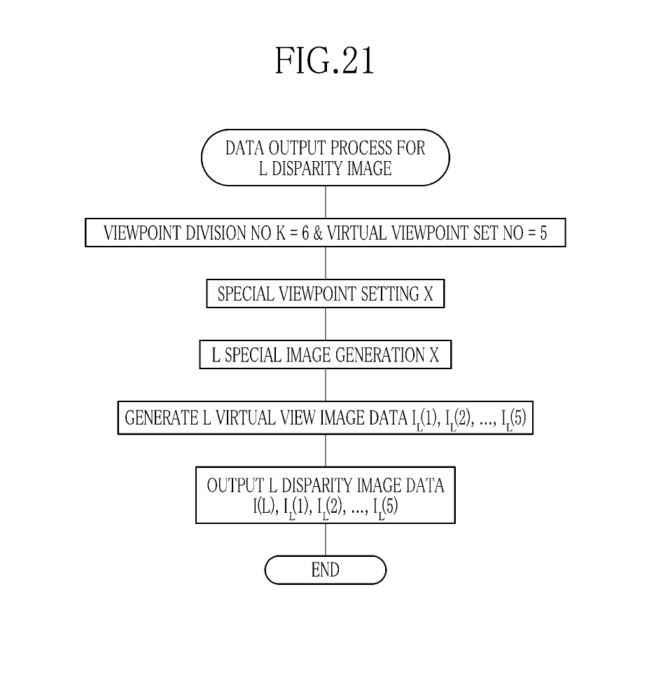

As shown in FIG. 21, a task of the data output process for the L disparity image data is decided. The number K of division of viewpoints is determined as “6”. The set number of virtual viewpoints is determined as “5”. Then the CPU 21 sends a command for a special viewpoint setting to the viewpoint setting unit 43.

As shown in FIG. 22, the viewpoint setting unit 43 upon receiving the special viewpoint setting carries out the special viewpoint setting X to set the virtual viewpoints V(1) to V(5). Then the CPU 21 sends a command for carrying out the L special image generation X to the image generation unit 78.

The image generation unit 78, upon receiving a command from the CPU 21, generates L virtual view image data IL(1) to IL(5) corresponding to virtual viewpoints V(1) to V(5) according to the optimum disparity map and L view image data I(L). Unlike the first embodiment, it is unnecessary to generate the disparity map 38L. It is possible to reduce load of the image processing device 64 and set a process time shorter than the first embodiment. Also, the disparity map stored previously is used. Even when an area of a region of the imaging error having occurred in one of the L and R view image data I(L) and I(R) is large, virtual view image data of a somewhat good quality can be obtained.

The L virtual view image data IL(1) to IL(5) are input to the image output unit 35. Then the CPU 21 sends a command for outputting L disparity image data to the image output unit 35. Thus, the image output unit 35 outputs the L disparity image data of the six viewpoints to the image recording unit 27, the L disparity image data including the L virtual view image data IL(1) to IL(5) and the L view image data I(L). Then the data output process for the L disparity image data is completed.

[Data Output Process for R Disparity Image Data]

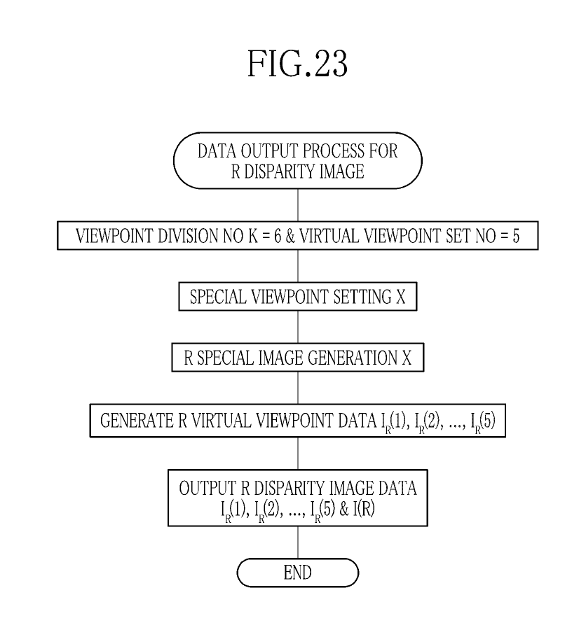

As shown in FIG. 23, the CPU 21 carries out the data output process for the R disparity image data in case of occurrence of an imaging error in the L view image data I(L). A flow of the data output process for the R disparity image data is basically the same as that of the data output process for the L disparity image data. In the data output process for the R disparity image data, however, the R virtual view image data IR(1) to IR(5) corresponding to the virtual viewpoint V(1) to V(5) are generated according to the optimum disparity map and the R virtual view image data I(R). Then the R disparity image data of the six viewpoints are output to the image recording unit 27, including the R virtual view image data IR(1) to IR(5) and the R view image data I(R). Thus, the data output process for the R disparity image data is completed.

Steps succeeding to outputting the L and R disparity image data are the same as the first embodiment, and are not described further. It is possible also in the third embodiment to view a 3-dimensional image acceptably because the virtual view image data are generated according to image data without occurrence of an imaging error.

In the third embodiment described above, the description has been made for the structure in which disparity image data of the six viewpoints is recorded to the sheet 17. It is possible to use the present invention for a structure in which disparity image data of three or more viewpoints is recorded to the sheet 17.

In the third embodiment described above, the disparity maps 71-73 for normal, portrait and landscape imaging are examples for disparity maps stored in the disparity map storage medium 65. However, disparity maps corresponding to various other object scenes can be stored. In the third embodiment, an object scene is detected according to the auxiliary information 62 of the image file 15. However, it is possible to use, for example, a well-known processing of face detection, and to detect an object scene according to a result of detecting presence of a face and its size in the L and R view image data I(L) and I(R).

In the third embodiment described above, five virtual viewpoints are set upon the data output process for L and R disparity image data of the six viewpoints. However, ten virtual viewpoints can be set to generate five virtual view image data in a manner similar to the first embodiment. It is possible to generate the virtual view image data in a manner similar to the first embodiment except for the use of the optimum disparity map instead of the disparity maps 38L and 38R.

### 4th Embodiment

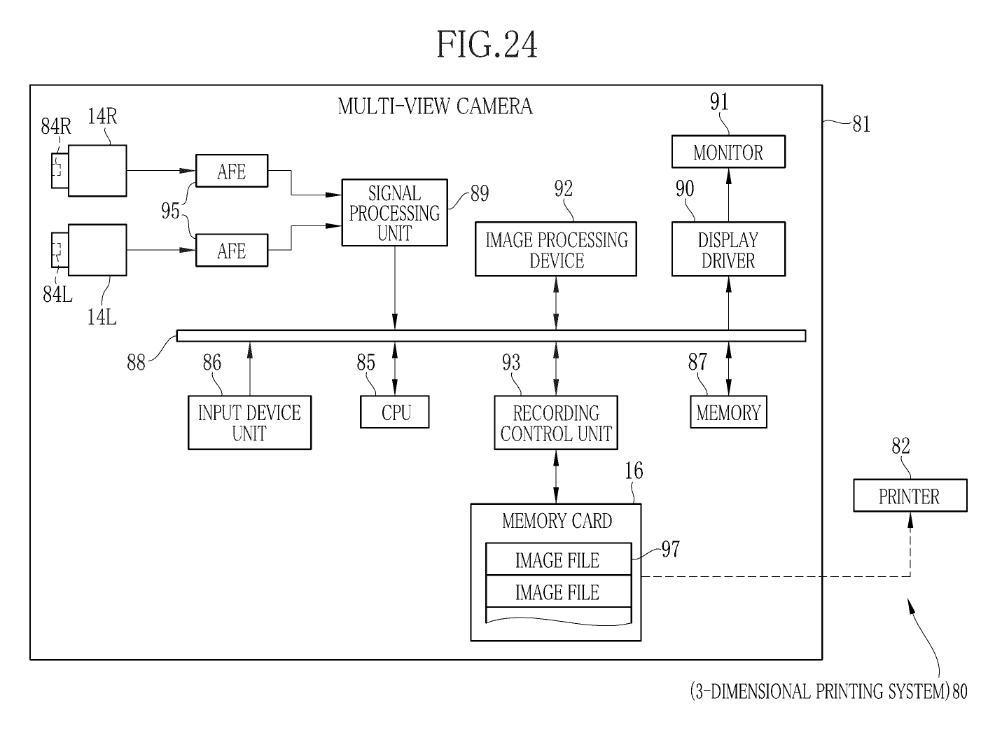

A 3-dimensional printing system 80 of the fourth embodiment of the present invention is described by referring to FIG. 24. In the above embodiments, the printer generates the virtual view image data. In the 3-dimensional printing system 80, a multi-view camera generates virtual view image data. The 3-dimensional printing system 80 is constituted by a multi-view camera 81 and a printer 82.

The multi-view camera 81 includes the pair of the imaging units 14L and 14R. The imaging units 14L and 14R include an image sensor which is not shown and the like in addition to the taking lenses 14a.

A CPU 85 operates according to a control signal from an input device unit 86, successively runs various programs and the like read from a memory 87, and entirely controls various elements of the multi-view camera 81. To the CPU 85 are connected the input device unit 86, the memory 87, a signal processing unit 89, a display driver 90, a monitor 91, an image processing device 92, a recording control unit 93 and the like by use of a bus 88.

The input device unit 86 is constituted by, for example, a power switch, a mode changer switch for changeover of operation modes of the multi-view camera 81 (for example, imaging mode and playback mode), a shutter button and the like.

An AFE (analog front end) 95 processes image signals of an analog form output by the imaging units 14L and 14R for processing of noise reduction, amplification of the image signals, and digitization, to generate L and R image signals. The L and R image signals are output to the signal processing unit 89.

The signal processing unit 89 processes the L and R image signals input from the AFE 95 in the image processing of various functions such as gradation conversion, white balance correction, gamma correction, YC conversion and the like, and creates L and R view image data I(L) and I(R). The signal processing unit 89 causes the memory 87 to store the L and R view image data I(L) and I(R).

At each time that the L and R view image data I(L) and I(R) are stored to the memory 87, the display driver 90 reads the L and R view image data I(L) and I(R) from the memory 87, generates a signal for displaying an image, and outputs the signal to the monitor 91 at a predetermined time sequence. Thus, a live image is displayed by the monitor 91.

The image processing device 92 operates when the shutter button of the input device unit 86 is depressed. The image processing device 92 is constructed in a basically equal manner to the image processing device 29 of the first embodiment. See FIG. 3 for the construction. The imaging error detection circuit 32 of the image processing device 92 detects an imaging error in the same method of detecting an imaging error as the first embodiment described above. It is possible to use detection sensors 84L and 84R disposed near to the taking lenses 14a for detecting a touch of a finger or the like even with a higher manufacturing cost of the multi-view camera 81. Occurrence of an imaging error can be detected according to a result of the detection of the detection sensors 84L and 84R.

The image reader 31 of the fourth embodiment reads the L and R view image data I(L) and I(R) from the memory 87. The image output unit 35 of the fourth embodiment causes the memory 87 to store the disparity image data of the six viewpoints or the L and R view image data.

The recording control unit 93 reads disparity image data or L or R view image data from the memory 87 when the shutter button of the input device unit 86 is depressed fully, and creates an image file 97 in which those are unified. The recording control unit 93 records the image file 97 to the memory card 16.

The printer 82 is constructed equally to the printer 12 of the first embodiment described above except for the lack of the image processing device 29. See FIG. 1 for the construction of the printer 82. The printer 82 carries out the image recording to the sheet 17 according to the disparity image data read from the memory card 16 or the L and R view image data.

In the fourth embodiment described above, the multi-view camera 81 generates disparity image data in contrast with its generation in the printer 10 in the first embodiment described above. However, it is possible also to generate disparity image data in the multi-view camera 81 in a manner of the generation in the printer 60 according to the third embodiment.

In the above embodiment, virtual view image data are generated according to the L and R view image data obtained by the dual lens camera as a multi-view camera. Furthermore, it is possible to use the present invention for generating virtual view image data by use of any two of view image data of three or more viewpoints obtained by a multi-view camera of three views or more. In each of the above embodiments, virtual viewpoints are defined between the L and R viewpoints. However, virtual viewpoints may be defined on a left side from the L viewpoint or on a right side from the R viewpoint.

In each of the above embodiments, the description has been made with the examples of the printer or multi-view camera for generating virtual view image data. However, it is possible to use the present invention in various apparatuses for generating virtual view image data, such as a 3-dimensional image display apparatus for 3-dimensional display according to a disparity image, and a display apparatus for displaying disparity images in a predetermined sequence.

### DESCRIPTION OF THE REFERENCE NUMERALS

10, 58, 80 3-dimensional printing system
11, 59, 81 multi-view camera
52, 60, 82 printer
29, 64, 92 image processing device
32 imaging error detection circuit
33 disparity map generation circuit
34, 67 image generation circuit for a virtual view image
35 image output unit
53 area detector
54 viewpoint setting control unit for virtual viewpoints
65 disparity map storage medium
66 disparity map output unit

1. An image generation device for generating a virtual view image according to first and second view images captured with disparity by imaging an object from different viewpoints, said virtual view image being set by viewing said object from a predetermined number of virtual viewpoints different from said viewpoints, said image generation device comprising:
a detection unit for detecting whether there is a failure in said first and second view images;
a disparity map generator for operating if one of said first and second view images is an abnormal image with said failure according to a result of detection of said detection unit, for extracting a corresponding point in said abnormal image corresponding respectively to a pixel in a normal image included in said first and second view images, and for generating a disparity map for expressing a depth distribution of said object according to a result of extraction;
an image generating unit for generating said virtual view image according to said disparity map and said normal image.

2. An image generation device as defined in claim 1, further comprising an image output unit for outputting said normal image and said virtual view image to a predetermined receiving device.

3. An image generation device as defined in claim 1, further comprising a viewpoint setting unit for setting a larger number of said virtual
viewpoints than said predetermined number between said viewpoints of said abnormal image and said normal image;
wherein said image generating unit selects said virtual viewpoints of said predetermined number among said virtual viewpoints set by said viewpoint setting unit in a sequence according to nearness to said viewpoint of said normal image.

4. An image generation device as defined in claim 3, wherein said virtual viewpoints are disposed equiangularly from each other about said object.

5. An image generation device as defined in claim 3, further comprising an area detector for detecting a region area where said failure has occurred in said abnormal image;
wherein said viewpoint setting unit makes a set number of said virtual viewpoints higher according to an increase of said area.

6. An image generation device as defined in claim 1, further comprising an image acquisition unit for acquiring said first and second view images from an imaging apparatus which includes plural imaging units for imaging said object from said different viewpoints.

7. An image generation device as defined in claim 6, wherein said failure includes at least any one of flare and an image of a blocking portion blocking a taking lens of said imaging units at least partially.

8. A printer comprising:
an image generation device in claim 1; and
a recording unit for, if either one of said first and second view images is said abnormal image, recording a stereoscopically viewable image to a recording medium according to said normal image and said virtual view image.

9. A printer as defined in claim 8, further comprising a warning device for displaying a warning if said failure has occurred with both of said first and second view images.

10. An image generation method of generating a virtual view image according to first and second view images captured with disparity by imaging an object from different viewpoints, said virtual view image being set by viewing said object from a predetermined number of virtual viewpoints different from said viewpoints, said image generation method comprising:
a detection step of detecting whether there is a failure in said first and second view images;
a disparity map generating step of, if one of said first and second view images is an abnormal image with said failure according to a result of detection of said detection step, extracting a corresponding point in said abnormal image corresponding respectively to a pixel in a normal image included in said first and second view images, and generating a disparity map for expressing a depth distribution of said object according to a result of extraction;
an image generating step of generating said virtual view image according to said disparity map and said normal image.

11. An image generation method as defined in claim 10, further comprising a viewpoint setting step of setting a larger number of said virtual viewpoints than said predetermined number between said viewpoints of said abnormal image and said normal image.

12. An image generation method as defined in claim 11, wherein said virtual viewpoints are disposed equiangularly from each other about said object.

13. An image generation method as defined in claim 11, further comprising an area detection step of detecting a region area where said failure has occurred in said abnormal image;
wherein in said viewpoint setting step, a set number of said virtual viewpoints is made higher according to an increase of said area.

14. An image generation method as defined in claim 10, wherein said failure includes at least any one of flare and an image of a blocking portion at least partially blocking a taking lens for imaging said object from at least one of said viewpoints.

15. An image generation device as defined in claim 1, further comprising a viewpoint setting unit for setting a larger number of said virtual viewpoints than said predetermined number between said viewpoints of said abnormal image and said normal image.

16. A printer as defined in claim 8, wherein said image generation device comprises a viewpoint setting unit for setting a larger number of said virtual viewpoints than said predetermined number between said viewpoints of said abnormal image and said normal image.

17. A printer as defined in claim 16, wherein said virtual viewpoints are disposed equiangularly from each other about said object.

18. A printer as defined in claim 16, wherein said image generation device comprises an area detector for detecting a region area where said failure has occurred in said abnormal image;
wherein said viewpoint setting unit makes a set number of said virtual viewpoints higher according to an increase of said area.

19. A printer as defined in claim 8, wherein said failure includes at least any one of flare and an image of a blocking portion at least partially blocking a taking lens for imaging said object from at least one of said viewpoints.

20. An image generation device as defined in claim 4, further comprising an area detector for detecting a region area where said failure has occurred in said abnormal image;
wherein said viewpoint setting unit makes a set number of said virtual viewpoints higher according to an increase of said area.
